(19) United States
(12) Patent Application Publication
(10) Pub. No.: US 2013/0070242 A1
(43) Pub. Date: Mar. 21, 2013

(54) SYSTEM AND ANALYTICAL METHOD FOR LASER-INDUCED BREAKDOWN SPECTROSCOPY

(71) Applicants: Tze-An Liu, Hsinchu City (TW); Chen-Wei Chen, Changhua County (TW); Yu-Tai Li, Taichung City (TW); Chen-Hsiu Liu, Taipei City (TW)

(72) Inventors: Tze-An Liu, Hsinchu City (TW); Chen-Wei Chen, Changhua County (TW); Yu-Tai Li, Taichung City (TW); Chen-Hsiu Liu, Taipei City (TW)

(73) Assignee: INDUSTRIAL TECHNOLOGY RESEARCH INSTITUTE, Hsinchu (TW)

(21) Appl. No.: 13/310,663

(22) Filed: Dec. 2, 2011

(30) Foreign Application Priority Data
Sep. 20, 2011 (TW) TW100133729

(51) Int. Cl. G01J 3/30

(52) U.S. Cl. 356/318

(57) ABSTRACT

A system for laser-induced breakdown spectroscopy (LIBS) is provided. The system for the LIBS includes a laser module generating a first pulse laser and a second pulse laser. An optical delay device incident by the second pulse laser is used to increase an optical path of the second pulse laser. A Kerr medium incident by the second pulse laser generates a time gate, and allows a plasma light beam generated from a sample incident by the first pulse laser, passing through the time gate and being output at a time point. A detection device receives and measures the plasma light beam output at the time point to generate a signal. A processing module connected to the detection device detects a signal, and compares the signal with a data base to obtain information concerning a composition and element concentrations of the sample.

### CROSS REFERENCE TO RELATED APPLICATIONS

This Application claims priority of Taiwan Patent Application No. 100133729, filed on Sep. 20, 2011, the entirety of which is incorporated by reference herein.

### BACKGROUND OF THE INVENTION

1. Field of the Invention

The disclosure relates to a system and an analytical method for spectroscopy, and in particular, to a system and analytical method for laser-induced breakdown spectroscopy (LIBS).

2. Description of the Related Art

In today of more and more concerning about the life quality, people are paying more and more attention of security and health to the life environment or the daily commodities. Now the standard detection method for the material for commonly used products (such as 3C (computers/communications/consumer) products, panels or solar panels), foods (such as Chinese herbal medicines), toys, environment (such as soil), valuable minerals (such as Au, Ag) etc. is a chemical detection method. The conventional chemical detection method has a complex detection procedure. First, a sample is required to be in-situ collected and shipped to the chemical laboratory, and then detection is made using a huge vacuum pump and cooling equipment. The sample is required to be specially prepared for placement into the detection equipment. Therefore, the detection time for the conventional chemical detection method is almost about a week. The detection equipment of the conventional chemical detection method has disadvantages of having high costs, being high labor intensive, having poor efficiency, and having a high technical barrier for operation.

Laser induced breakdown spectroscopy (LIBS) or laser induced plasma spectroscopy (LIPS) is an analytical technology of materials to determine the chemical components of solids, liquids and gasses. The conventional LIBS laboratory system is being used by industries and governments for detection and analysis of chemical materials. The laser ablation method used in laser-ablation inductively-coupled-plasma mass-spectrometry (LA-ICP-MS) and laser-ablation inductively-coupled-plasma optical-emission-spectrometry (LA-ICP-OES) is also used in trace element detection. Generally, LIBS equipment is considered less costly than laser ablation equipment. Accordingly, the use of LIBS for trace element detection has increased. However, noise is a problem for a plasma spectroscopy generated by LIBS, and the time point of LIBS with the best signal-to-noise (S/N) ratio is difficult to obtain. Therefore, LIBS used for trace element detection, results in poor accuracy and precision.

Thus, a novel system and analytical method for laser-induced breakdown spectroscopy (LIBS) is desired to improve the aforementioned problems.

### BRIEF SUMMARY OF INVENTION

A system and an analytical method for laser-induced breakdown spectroscopy are provided. An exemplary embodiment of a system for laser-induced breakdown spectroscopy, comprises a laser module generating a first pulse laser and a second pulse laser. An optical delay device incident by the second pulse laser, is used to increase t an optical path of the second pulse laser. A Kerr medium is incident by the second pulse laser with the increased optical path, generates a time gate, and allows a plasma light beam generated from a sample, which is incident by the first pulse laser, passing through the time gate and is output at a time point. A detection device is used to receive and measure the plasma light beam output at the time point to generate a signal. A processing module connected to the detection device, detects a signal, and compares the signal with a data base to obtain information concerning a composition and element concentrations of the sample.

Another exemplary embodiment of a system for laser-induced breakdown spectroscopy, comprises a laser module generating a first pulse laser. An interferometer allows a plasma light beam generated from a sample, which is incident by the first pulse laser, passing through the time gate and is output at a particular wavelength or frequency position. A detection device is used to receive and measure the plasma light beam output at the particular wavelength or frequency position to generate a signal. A processing module connected to the detection device, detects a signal, and compares the signal with a data base to obtain information concerning a composition and element concentrations of the sample.

An exemplary embodiment of an analytical method for laser-induced breakdown spectroscopy, comprises using a laser module to generate a first pulse laser and a second pulse laser. A plasma light beam is generated from a sample, which is incident by the first pulse laser, wherein the second pulse laser incident on an optical delay device and a Kerr medium in sequence to generate a time gate. Next, the plasma light beam passes through an interferometer with a first cavity length and is output at a first wavelength position. Next, the plasma light beam is output at the first wavelength position passing through the time gate and is output at a first time point, thereby obtaining the plasma light beam outputted at the first wavelength position and the first time point. Next, the optical delay device moves along a light axis of the second pulse laser, so that the time gate opens at a second time point different from the first time point, thereby obtaining the plasma light beam output at the first wavelength position and the second time point.

A detailed description is given in the following embodiments with reference to the accompanying drawings.

### BRIEF DESCRIPTION OF DRAWINGS

The disclosure can be more fully understood by reading the subsequent detailed description and examples with references made to the accompanying drawings, wherein:

FIG. 1 is a schematic diagram showing a structure of one exemplary embodiment of a system for laser-induced breakdown spectroscopy of the disclosure.

FIG. 2a is a schematic diagram showing a time gate of one exemplary embodiment of a system for laser-induced breakdown spectroscopy of the disclosure.

FIG. 2b is a diagram showing intensity of a plasma light beam versus time of the plasma light beam for passing a time gate.

FIG. 2c is a diagram showing intensity of a plasma light beam versus wavelength of the plasma light beam for passing a time gate.

FIG. 3a is a diagram showing a signal-to-noise (S/N) ratio of a plasma light beam excited by a sample versus time and wavelength.

FIG. 3b is a schematic diagram showing laser-induced breakdown spectroscopy of a sample measured by one exemplary embodiment of a system for laser-induced breakdown spectroscopy of the disclosure.

### DETAILED DESCRIPTION OF INVENTION

The following description is of a mode for carrying out the disclosure. This description is made for the purpose of illustrating the general principles of the disclosure and should not be taken in a limiting sense. The scope of the disclosure is best determined by reference to the appended claims. Wherever possible, the same reference numbers are used in the drawings and the descriptions to refer the same or like parts.

The disclosure will be described with respect to particular embodiments and with reference to certain drawings, but the disclosure is not limited thereto and is only limited by the claims. The drawings described are only schematic and are non-limiting. In the drawings, the size of some of the elements may be exaggerated and not drawn to scale for illustrative purposes. The dimensions and the relative dimensions do not correspond to actual dimensions to practice the disclosure.

Exemplary embodiments provide a system and analytical method for multiple time-resolved and multiple wavelength-resolved laser-induced breakdown spectroscopy (LIBS). The system for time-resolved and wavelength-resolved laser-induced breakdown spectroscopy may comprise two portions. One portion uses an ultra-short pulse laser to excite a sample to generate a laser-induced breakdown spectroscopy (LIBS) or laser-induced plasma spectroscopy (LIPS). Another portion uses multiple time-resolved signal sampling technology and a multiple wavelength-resolved interferometer to measure an LIBS or LIPS signal intensity and signal-to-noise (S/N) ratio of a sample at different wavelength positions and time points. Therefore, the best S/N ratio at each of the different spectroscopy positions is found. Exemplary embodiments of the system and analytical method for time-resolved and wavelength-resolved LIBS can solve the measurement limitations of element concentration of the conventional system and analytical method for the LIBS, thereby the exemplary embodiments are especially suitable for in-situ heavy metal component measurements of Chinese herbal medicines, soil and the like.

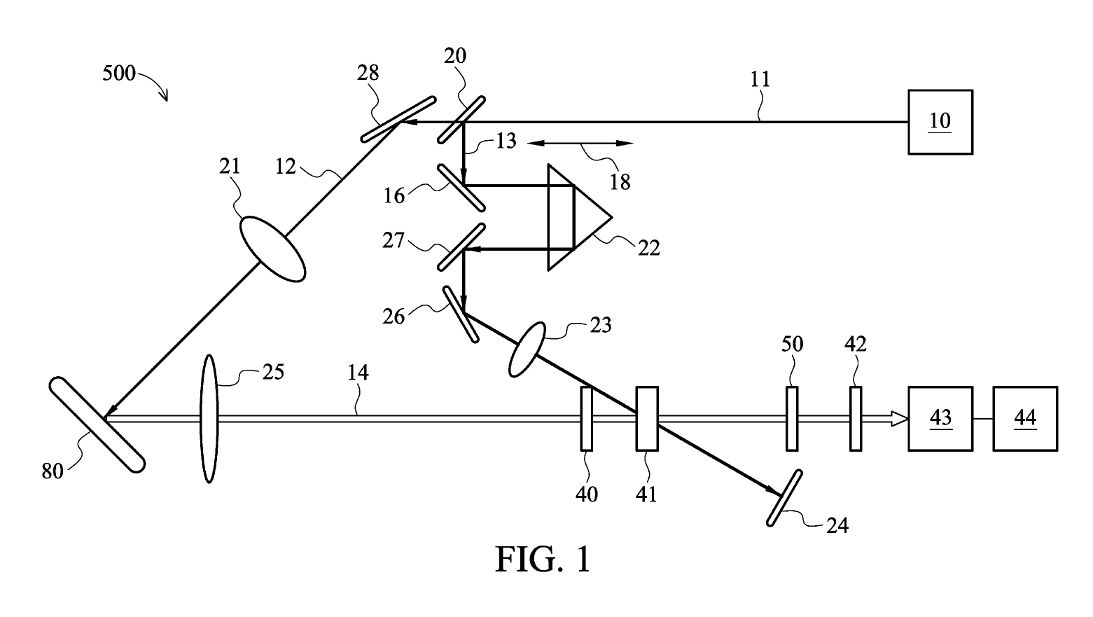

FIG. 1 is a schematic diagram showing a structure of one exemplary embodiment of a system 500 for laser-induced breakdown spectroscopy (LIBS) of the disclosure. As shown in FIG. 1, the system for the LIBS 500 may comprise a laser module 10 used to generate an initial pulse laser 11, wherein the initial pulse laser is split into a first pulse laser 12 and a second pulse laser 13 by a beamsplitter 20. In one embodiment, the initial pulse laser 11 generated by the laser module 10 is an ultra-short pulse laser (also referred to as a femtosecond laser), for example, a Ti:sapphire laser. An advancing direction of the first pulse laser 12 is changed by a reflection minor 28, and then the first pulse laser 12 passes through a lens 21 to be incident and focused on a sample 80 (the first pulse laser 12 impacts the sample 80). When the sample 80 reaches an electron ionization temperature, a plasma light beam 14 is generated. The plasma light beam 14 generated by exciting the sample 80 has an LIBS or LIPS varied with time. Additionally, the plasma light beam 14 through the lens 25 passes through a polarizer 40, which serves as a polarization device, wherein thereafter, the plasma light beam 14 is incident to a Kerr medium 41.

Additionally, an advancing direction of the second pulse laser 13 is optionally changed by another reflection minor 16, and then the second pulse laser 13 passes through an optical delay device 22. Next, the advancing direction of the second pulse laser 13 is changed by two reflection minors 26 and 27 and a lens 23 to be incident and focused on the Kerr medium 41. Next, the second pulse laser 13 is incident to a beam dump 24 to cut off the second pulse laser 13. As shown in FIG. 1, the second pulse laser 13 can coincide with the plasma light beam 14 at the Kerr medium 41. In one embodiment, the optical delay device 22 may be composed by one or more reflection mirrors, and the optical delay device 22 can move along a light axis 18 of the second pulse laser 13. The optical delay device 22 can generate a time delay of the second pulse laser 13 by increasing an optical path of the second pulse laser 13.

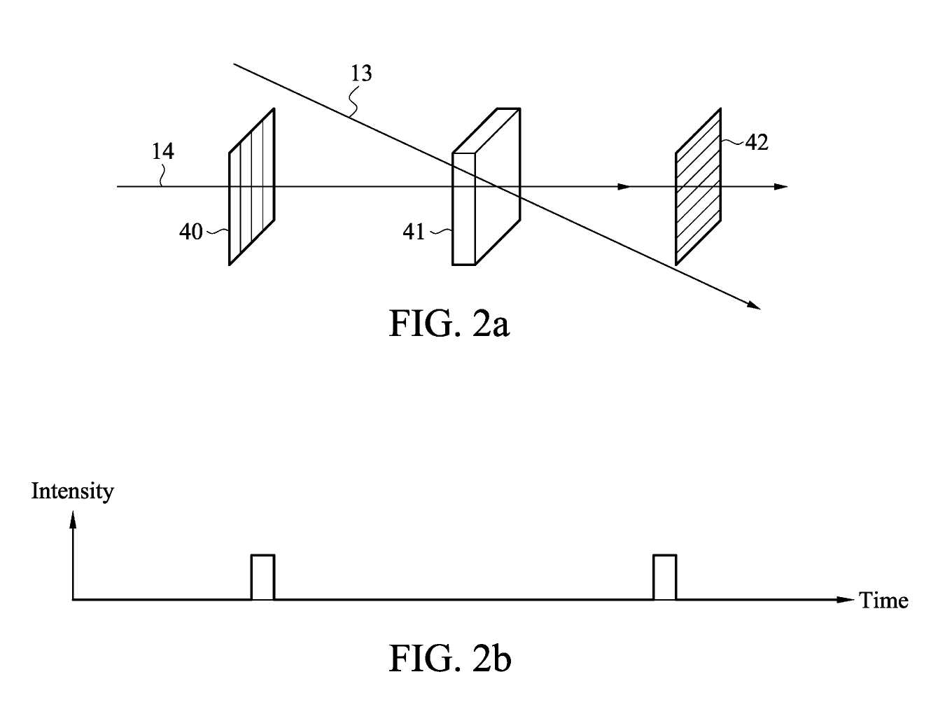

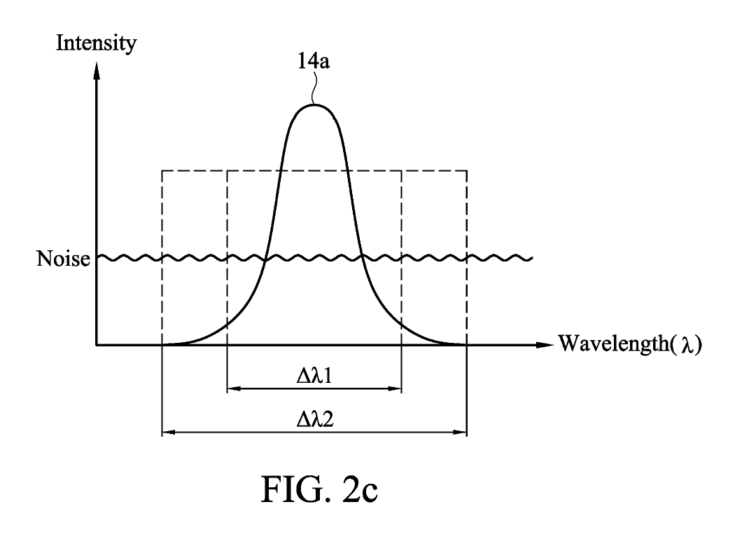

FIG. 2a is a schematic diagram showing a time gate of one exemplary embodiment of a system for laser-induced breakdown spectroscopy of the disclosure. FIG. 2b is a diagram showing intensity of a plasma light beam versus time of the plasma light beam for passing a time gate. In one embodiment, the Kerr medium 41 is a non-linear medium, and materials of the Kerr medium 41 may comprise CS₂. The Kerr medium 41 with a high intensity (such as excited by a pulse laser) can be birefringence (optical Kerr effect) in a very short period of time (picosecond (ps)), thereby serving as a time gate. As shown in FIGS. 2a and 2b, when the second pulse laser 13 excites the Kerr medium 41 to generate a time gate, the plasma light beam 14 passes through the Kerr medium (time gate) 41 only at one period of time. Also, the second pulse laser 13 used to excite the Kerr medium 41 has a periodically changing electric field, so that the time gate opens periodically (as shown in FIG. 2b). In one embodiment, a narrow width (opening time) of the time gate generated by using an fs-pulse laser to excite the Kerr medium 41 of CS₂ is about 800 fs. A repetition rate of the time gate is from a single shot to 1 GHz. Additionally, because the Kerr medium 41 is a non-linear medium, when the light beam passes through the Kerr medium 41, the light beam has a phase difference of λ/2. Therefore, as shown in FIGS. 1 and 2a, a polarizer 40 (serves as a polarization device) and a polarizer 42 (serves as a depolarization device) may be respectively disposed at opposite sides of the Kerr medium 41 to filter a phase of the plasma light beam 14, wherein the plasma light beam 14 passing the time gate passes through the polarizer 40, the Kerr medium 41 and the polarizer 42 in sequence. Polarization directions of the polarizers 40 and 42 are vertical to each other.

Therefore, the second pulse laser 13 incident to the Kerr medium 41 is used to excite the Kerr medium 41 to generate a time gate opening periodically. The Kerr medium 41 serving as a time gate allows a plasma light beam 14 generated by exciting the sample 80 using the first pulse laser 12, passing the time gate and being output at a time point, to obtain a time-resolved LIBS or LIPS. The time gate generated by using an fs pulse laser to excite the Kerr medium 41 has a very short opening time period (the narrow width of the time gate is about 800 fs), so that the time resolution of the LIBS or LIPS is improved Additionally, the second pulse laser 13 can postpone being incident to the Kerr medium 41 to delay an open time of the time gate by adjusting the optical delay device 22 (moving along the light axis 18), thereby obtaining multiple (different time points) time-resolved LIBS or LIPS. The system 500 for the LIBS or LIPS can further obtain the time point of the LIBS or LIPS with the best S/N ratio. Therefore, the sample component can be precisely obtained, and the measurement limit of the system can be improved.

As shown in FIG. 1, the system 500 for the LIBS may further comprise an interferometer 50 disposed between the Kerr medium 41 and a detection device 43. In one embodiment, the interferometer 50 may be disposed between the Kerr medium 41 and the polarizer 42. Alternatively, the interferometer 50 may be disposed between the polarizer 42 and the detection device 43. In one embodiment, the interferometer 50 may be a Fabry-Perot interferometer composed by two high reflectivity minors parallel to each other. An incident light is reflected many times between the two minors. Any two adjacent reflection light beams or transmission light beams may have a light path difference. When a cavity length (a distance between the two minors) of the interferometer is equal to an integer multiple of the half-wavelength (Nλ/2) of the incident light, a constructive interference occurs to increase an output light beam intensity, so that the interferometer 50 may serve as a wavelength gate. Therefore, the plasma light beam 14 passing through the time gate (the Kerr medium 41) can pass through a wavelength gate again, and is output at a wavelength position or a frequency position, thereby obtaining a time-resolved and wavelength-resolved LIBS of the sample 80.

FIG. 2c is used to describe a principle of improving the S/N ratio of the plasma light beam passing through the wavelength gate. Because the interferometer 50 such as the Fabry-Perot interferometer has a very narrow output width (the narrowest output width is about 1 GHz), the plasma light beam passing through the wavelength gate is only output at a very narrow wavelength region. In one embodiment as shown in FIG. 2c, compared with a wavelength gate having a width such as Δλ2, when the wavelength gate having a narrow output width (such as Δλ1) is adjusted for the plasma light beam 14 which passes through the wavelength gate, only a plasma light beam signal with a high intensity is allowed to pass through the wavelength gate, wherein the plasma light beam signal with low intensity is blocked by the wavelength gate. Therefore, the wavelength gate can suppress noise from the time-resolved and wavelength-resolved LIBS of the sample, thereby improving the S/N ratio of LIBS of the sample.

As shown in FIG. 1, the time-resolved and wavelength-resolved LIBS (or LIPS) of the sample can be obtained by the step of measuring of the plasma light beam 14 output at a time point and a frequency position by the detection device 43 to generate a signal. Next, a processing module 44 (such as a computer) connected to the detection device 43 detects the signal, and compares the signal with a data base to obtain the composition with the best S/N ratio and information concerning a composition and element concentrations of the sample.

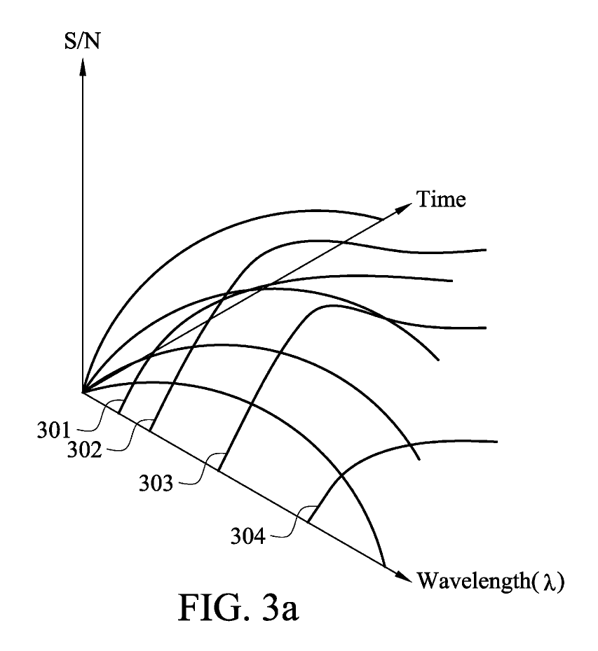

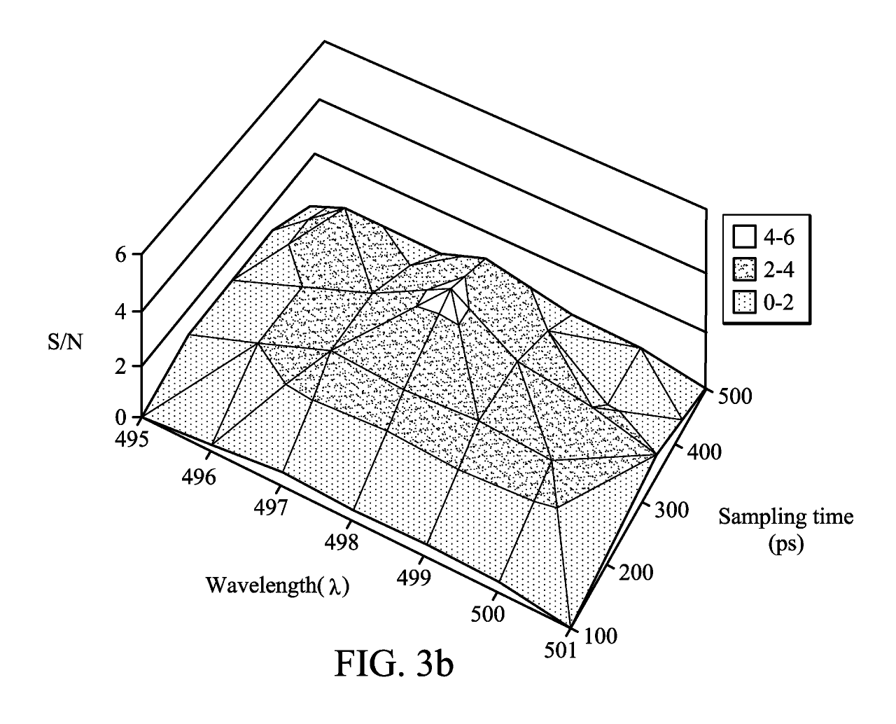

FIGS. 3a and 3b are used to describe one exemplary embodiment of an analytical method for the LIBS of the disclosure. FIG. 3a is a diagram showing the S/N ration of the plasma light beam 14 by exciting a sample versus time and wavelength. Embodiments provide an analytical method for the LIBS, which uses a laser module to generate an fs-leveled first and second pulse laser. The first pulse laser is used to excite a sample to generate a plasma light beam. The plasma light beam is processed with a multiple wavelength-resolved interferometer and a multiple time-resolved signal sampling device (a Kerr medium and an optical delay device). After generating the plasma light beam by exciting the sample using the first pulse laser, the interferometer (a wavelength gate) with a first cavity length is used to allow the plasma light beam which passes through the interferometer to be output at a wavelength position. Next, the plasma light beam output at the wavelength position passes through the Kerr medium (a time gate) excited by the second pulse laser and is output at a first time point, thereby obtaining the plasma light beam output at the wavelength position and the first time point. Next, the optical delay device moves along a light axis of the second pulse laser, so that the time gate may open at a second time point different from the first time point (that is to say, the opening time of the time gate is delayed), thereby obtaining the plasma light beam output at the wavelength position and the second time point. Next, the aforementioned steps are repeated to change an opening time point of the time gate, thereby obtaining a signal of the plasma light beam (or the S/N ratio) output at the wavelength position and varied with time as shown in the line 301 of FIG. 3a. Next, the interferometer is adjusted from the first cavity length to a second cavity length, so that the plasma light beam is output at another wavelength position. The time gate is then adjusted to be opened at different time points for the plasma light beam which passes through the time gate, thereby obtaining a signal of the plasma light beam (or the S/N ratio) output at another wavelength position and varied with time as shown in a line 302/303/304 of FIG. 3a. Also, the aforementioned steps are repeated again to change the time point and the wavelength position for the plasma light beam passing through the time gate, so that the corresponding wavelength position and the time point of a signal of the plasma light beam with the best S/N ratio is measured by the detection device. A processing module (such as a computer) is used to obtain the composition with the best S/N ratio and information concerning a composition and element concentrations of the sample by comparing the signal with a data base. The data base may be constructed by the theories of molecular dynamics or fluid dynamics, or constructed by experimental data. FIG. 3b is an LIBS diagram of a sample obtained by one exemplary embodiment of a system for the LIBS of the disclosure. Each of the turning points in FIG. 3b is a wavelength position while the wavelength gate is opening and a time point while the time gate is opening. From FIG. 3b, one exemplary embodiment of a system for the LIBS of the disclosure can obtain an LIBS having a high time-resolution (from femtosecond (fs) to picosecond (ps)) and a high wavelength-resolution.

Exemplary embodiments of a system and an analytical method for the LIBS of the disclosure have the following advantages. The time gate with a very short opening time (the minimum opening time is about 800 fs) generated by exciting the Kerr medium using an fs-pulse laser is used to improve the time-resolution of the system. Also, the Fabry-Perot interferometer is used to replace the conventional interferometer, serving as a wavelength gate with a very narrow width to improve the frequency-sensitivity of the device. Therefore, the S/N ratio for the LIBS of the sample is improved in time and frequency respects. The measurement limit of the device is further improved. Additionally, one exemplary embodiment of a system and an analytical method for the LIBS of the disclosure has a small volume and a simple construction, thereby applicable as a commercialized trace element detector for non-contacting in-situ detection. Results can be obtained in just a few seconds. One exemplary embodiment of a system and an analytical method for the LIBS of the disclosure can solve the problems of complex detection, and can replace the conventional expensive detector. One exemplary embodiment of a system and an analytical method for the LIBS of the disclosure can use as a detector for daily commodities (such as 3C products, panels or solar panels), foods (such as Chinese herbal medicines), toys, environment (such as soil), valuable mineral (such as Au, Ag), and etc.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for laser-induced breakdown spectroscopy, comprising:
a laser module generating a first pulse laser and a second pulse laser;
an optical delay device incident by the second pulse laser, used to increase the an optical path of the second pulse laser;
a Kerr medium incident by the second pulse laser with the increased optical path, generating a time gate, and allowing a plasma light beam generated from a sample, which is incident by the first pulse laser, passing through the Kerr medium and being output at a time point;
a detection device used to receive and measure the plasma light beam output at the time point to generate a signal; and
a processing module connected to the detection device, detecting a signal, and comparing the signal with a data base to obtain information concerning a composition and element concentrations of the sample.

2. The system for laser-induced breakdown spectroscopy as claimed in claim 1, further comprising an interferometer disposed between the Kerr medium and the detection device, wherein the interferometer incident by the plasma light beam passing the time gate allows the plasma light beam passing the time gate to be output at a particular wavelength or frequency position.

3. The system for laser-induced breakdown spectroscopy as claimed in claim 1, wherein the narrowest width of time gate is about 800 fs.

4. The system for laser-induced breakdown spectroscopy as claimed in claim 1, wherein the first pulse laser and the second pulse laser are femtosecond pulse lasers, and a repetition rate of the time gate is from a single shot to 1 GHz.

5. The system for laser-induced breakdown spectroscopy as claimed in claim 2, wherein the interferometer is a Fabry-Perot interferometer, and the narrowest output width is about 1 GHz.

6. The system for laser-induced breakdown spectroscopy as claimed in claim 1, wherein the optical delay device is composed by one or more reflection mirrors, and the optical delay device moves along a light axis of the second pulse laser.

7. The system for laser-induced breakdown spectroscopy as claimed in claim 1, wherein the laser module generates an initial pulse laser, and the initial pulse laser is split into the first pulse laser and the second pulse laser by a beamsplitter.

8. The system for laser-induced breakdown spectroscopy as claimed in claim 1, further comprising a first polarizer and a second polarizer respectively disposed at opposite sides of the Kerr medium, wherein the plasma light beam passing through the time gate passes through the first polarizer, the Kerr medium and the second polarizer in sequence.

9. The system for laser-induced breakdown spectroscopy as claimed in claim 8, wherein polarization directions of the first and second polarizers are vertical to each other.

10. The system for laser-induced breakdown spectroscopy as claimed in claim 1, wherein the second pulse laser with the increased optical path coincides with the plasma light beam at the Kerr medium.

11. A system for laser-induced breakdown spectroscopy, comprising:
a laser module generating a first pulse laser;
an interferometer allowing a plasma light beam generated from a sample, which is incident by the first pulse laser, passing through the interferometer and being output at a particular wavelength or frequency position;
a detection device used to receive and measure the plasma light beam output at the particular wavelength or frequency position to generate a signal; and
a processing module connected to the detection device, detecting a signal, and comparing the signal with a data base to obtain information concerning a composition and element concentrations of the sample.

12. The system for laser-induced breakdown spectroscopy as claimed in claim 11, further comprising:
an optical delay device incident by a second pulse laser generated by the laser module, used to increase an optical path of the second pulse laser; and
a Kerr medium incident by the second pulse laser with the increased optical path, generating a time gate, and allowing a plasma light beam generated from the sample, which is incident by the first pulse laser passing through the time gate and being output at a time point, wherein the detection device measures the plasma light beam output at the time point and the wavelength or frequency position.

13. The system for laser-induced breakdown spectroscopy as claimed in claim 12, wherein the narrowest width of time gate is about 800 fs.

14. The system for laser-induced breakdown spectroscopy as claimed in claim 12, wherein the first pulse laser and the second pulse laser are femtosecond pulse lasers, and a repetition rate of the time gate is from a single shot to 1 GHz.

15. The system for laser-induced breakdown spectroscopy as claimed in claim 11, wherein the interferometer is a Fabry-Perot interferometer, and the narrowest output width is about 1 GHz.

16. The system for laser-induced breakdown spectroscopy as claimed in claim 12, wherein the optical delay device is composed by one or more reflection minors, and the optical delay device moves along a light axis of the second pulse laser.

17. The system for laser-induced breakdown spectroscopy as claimed in claim 12, wherein the laser module generates an initial pulse laser, and the initial pulse laser is split into the first pulse laser and the second pulse laser by a beamsplitter.

18. The system for laser-induced breakdown spectroscopy as claimed in claim 12, further comprising a first polarizer and a second polarizer respectively disposed at opposite sides of the Kerr medium, wherein the plasma light beam passing through the time gate passes through the first polarizer, the Kerr medium and the second polarizer in sequence.

19. The system for laser-induced breakdown spectroscopy as claimed in claim 18, wherein polarization directions of the first and second polarizers are vertical to each other.

20. The system for laser-induced breakdown spectroscopy as claimed in claim 12, wherein the second pulse laser with the increased optical path coincides with the plasma light beam at the Kerr medium.

21. An analytical method for laser-induced breakdown spectroscopy, comprising:
using a laser module to generate a first pulse laser and a second pulse laser;
generating a plasma light beam from a sample, which is incident by the first pulse laser, wherein the second pulse laser is incident an optical delay device and a Kerr medium in sequence along a light axis direction to generate a time gate;
the plasma light beam passing through an interferometer with a first cavity length and being output at a first wavelength position;
the plasma light beam outputted at the first wavelength position passing through the time gate and being output at a first time point; and
moving the optical delay device along the light axis of the second pulse laser, so that the time gate opens at a second time point different from the first time point, allowing the plasma light beam being output at the first wavelength position and the second time point.

22. The analytical method for laser-induced breakdown spectroscopy as claimed in claim 21, further comprising:
adjusting the interferometer to a second cavity length different from the first cavity length to allow the plasma light beam passing through the interferometer and being output at a second wavelength position;
the plasma light beam outputted at the second wavelength position passing through the time gate and being output at a first time point; and
moving the optical delay device along a light axis of the second pulse laser, so that the time gate opens at a second time point different from the first time point, thereby allowing the being output at the second wavelength position and the second time point.
